(19) United States
(12) Patent Application Publication
(10) Pub. No.: US 2015/0200820 A1
(43) Pub. Date: Jul. 16, 2015

(54) PROCESSING AN ATTEMPTED LOADING OF A WEB RESOURCE

(71) Applicant: Google Inc., Mountain View, CA (US)

(72) Inventor: Kenneth Brian MOORE, Seattle, WA (US)

(73) Assignee: Google Inc., Mountain View, CA (US)

(21) Appl. No.: 13/802,475

(22) Filed: Mar. 13, 2013

(51) Int. Cl. H04L 12/26

(52) U.S. Cl. CPC H04L 43/04

(57) ABSTRACT

A system and machine-implemented method for processing an attempted loading of a web resource. A load report is received from a client device, the load report indicating a result of an attempted loading of a web resource by an application on the client device. The web resource is hosted by a web server. A confidence score for the web server is adjusted based on the load report. The confidence score for the web server represents an operational state of the web server. If the result of the attempted loading of the web resource indicated by the load report is an unsuccessful result, a response is generated for the application on the client device, based on the confidence score for the web server, and the generated response is provided to the client device for processing by the application.

### BACKGROUND

The present disclosure generally relates to loading web resources, in particular, to processing an attempted loading of a web resource.

When a user of an application (e.g., a web browser) attempts to load a web resource (e.g., a webpage) from a web server that is down, the application may present the user with an generic error message. However, the error message presented to the user may include limited information.

### SUMMARY

The disclosed subject matter relates to a machine-implemented method of processing an attempted loading of a web resource. The method comprises receiving, from a client device, a load report indicating a result of an attempted loading of a web resource by an application on the client device, wherein the web resource is hosted by a web server, and adjusting a confidence score for the web server based on the load report, wherein the confidence score for the web server represents an operational state of the web server. The method further comprises, if the result of the attempted loading of the web resource indicated by the load report is an unsuccessful result, generating a response for the application on the client device, based on the confidence score for the web server, and providing the generated response to the client device for processing by the application.

The disclosed subject matter further relates to machine-implemented method of processing an attempted loading of a web resource. The method comprises requesting, by an application on a client device, loading of a web resource hosted by a web server, generating a load report indicating a result of the loading of the web resource by the application, and transmitting the load report to a system server. The method further comprises receiving, if the result of the loading of the web resource indicated by the load report is an unsuccessful result, a response from the system server, wherein the received response is based on a confidence score for the web server, and wherein the confidence score is based on the load report and represents an operational state of the web server.

The disclosed subject matter also relates to a system for processing an attempted loading of a web resource. The system comprises one or more processors, and a machine-readable medium comprising instructions stored therein, which when executed by the processors, cause the processors to perform operations comprising receiving, from a client device, a load report indicating a result of an attempted loading of a web resource by an application on the client device, wherein the web resource is hosted by a web server. The operations further comprise adjusting a confidence score for the web server based on the load report, wherein the confidence score for the web server represents a level of certainty that the web server is operational. In addition, the operations comprise, if the result of the attempted loading of the web resource indicated by the load report is an unsuccessful result, generating a response for the application on the client device, based on the confidence score for the web server, and providing the generated response to the client device for processing by the application.

The disclosed subject matter also relates to a system for processing an attempted loading of a web resource. The system comprises one or more processors, and a machine-readable medium comprising instructions stored therein, which when executed by the processors, cause the processors to perform operations comprising requesting, by an application on a client device, loading of a web resource hosted by a web server. The operations further comprise generating a load report indicating a result of the loading of the web resource by the application, and transmitting the load report to a system server. In addition, the operations comprise receiving, if the result of the loading of the web resource indicated by the load report is an unsuccessful result, a response from the system server, wherein the received response is based on a confidence score for the web server, and wherein the confidence score is based on the load report and represents a level of certainty that the web server is operational.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates an example network environment which can provide for processing an attempted loading of a web resource.

FIG. 2 illustrates an example of a graphical interface which provides notification of an unsuccessful attempt to load a web resource from a web server.

FIG. 3 illustrates another example of a graphical interface which provides notification of an unsuccessful attempt to load a web resource from a web server.

FIG. 4 illustrates an example process by which all attempted loading of a web resource is processed.

FIG. 5 illustrates another example process by which an attempted loading of a web resource is processed.

FIG. 6 illustrates yet another example process by which an attempted loading of a web resource is processed.

FIG. 7 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As noted above, when a user of an application (e.g., a web browser) attempts to load a web resource (e.g., a webpage) from a web server that is down, the application may present the user with an generic error message. As used herein, a “generic error message” encompasses its plain and ordinary meaning, including but not limited to a message notifying an end user of a connection failure between two devices. The generic error message may not include much information. For example, the generic error message may not provide the user with any guidance as to how to respond to the failed attempt to load the website.

Various aspects of the subject technology relate to providing an informed response to a failed attempt to load a web resource (e.g., a webpage). The informed response may be used to inform the user as to whether the lack of response from the website is specific to the user, or if other users are unable to access the website. The informed response may also be used to determine how long the website has been down, when to retry, or how to respond.

The subject disclosure provides for processing an attempted loading of a web resource. A server system receives a load report from a client device. The load report indicates a result of an attempted loading of a web resource by an application on the client device, the web resource being hosted by a web server. The server system adjusts a confidence score for the web server based on the load report, the confidence score for the web server representing an operational state of the web server. If the result of the attempted loading of the web resource indicated by the load report is an unsuccessful result, the system server generates a response for the application on the client device, based on the confidence score for the web server, and provides the generated response to the client device for processing by the application.

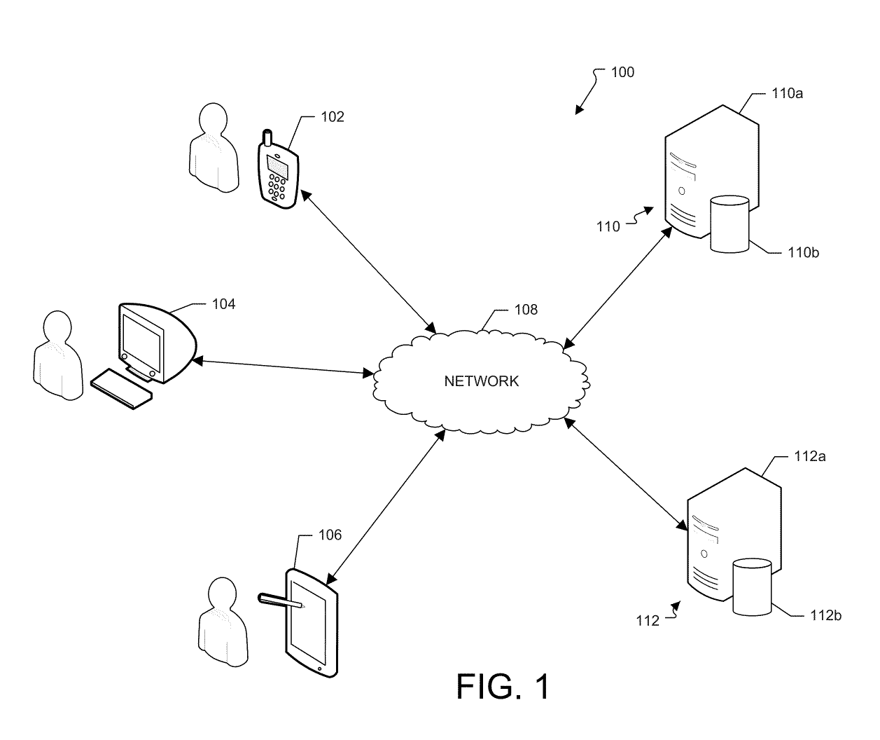

FIG. 1 illustrates an example network environment which can provide for processing an attempted loading of a web resource. A network environment 100 includes computing devices 102, 104 and 106 (hereinafter “102-106”) and computing systems 110 and 112 (hereinafter “110-112”). Computing devices 102-106 and computing systems 110-112 can communicate with each other through a network 108. Each of computing systems 110-112 can include one or more computing devices 110a-112a (e.g., one or more servers), respectively, and one or more computer-readable storage devices 110b-112b (e.g., one or more databases), respectively.

Each of computing devices 102-106 can represent various forms of processing devices. Example processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Computing devices 102-106 and 110a-112a may be provided access to or receive application software executed or stored on any of the other computing systems 102-106 and 110a-112a.

Each of computing devices 110a-112a may be any system or device having a processor, a memory, and communications capability for providing content to the electronic devices. In some example aspects, each of servers 110-112 can be a single computing device, for example, a computer server. In other embodiments, each of servers 110-112 can represent more than one computing device working together to perform the actions of a server computer (e.g., cloud computing). Further, each of computing devices 110a-112a can represent various forms of servers including, but not limited to a web server, an application server, a proxy server, a network server, or a server farm.

In some aspects, the computing devices may communicate wirelessly through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, WiFi, or other such transceiver.

In some aspects, network environment 100 can be a distributed client/server system that spans one or more networks, for example, network 108. Network 108 can be a large computer network, for example, a local area network (LAN), wide area network (WAN), the Internet, a cellular network, or a combination thereof connecting any number of mobile clients, fixed clients, and servers. Further, the network 108 can include, but is not limited to, any one or more of the following network topologies, including a bus network, a star network, a ring network, a mesh network, a star-bus network, tree or hierarchical network, and the like. In some aspects, communication between each client (e.g., computing devices 102-106) and server (e.g., servers 110-112) can occur via a virtual private network (VPN), Secure Shell (SSH) tunnel, or other secure network connection. In some aspects, network 108 may further include a corporate network intranet and one or more wireless access points.

In example aspects, server 110 is a web server which can provide web resources to one or more client devices (e.g., computing devices 102-106). For example, processing device 110a executes computer instructions stored in data store 110b, for example, to host a website. A user of any of computing devices 102-106 can request a web resource (e.g., a webpage) via an application (e.g., web browser) on the computing device. At times, it is possible that server 110 is unable to provide the web resource to the application, for example, because server 110 is currently not operational.

In this regard, and in example aspects, processing device 112a executes computer instructions stored in data store 112b, for example, to process an attempted loading of a web resource. Server 112 can be referred to herein as a “server system.” Server 112 can receive a load report from a client device e.g., any of computing devices 102-106). The load report indicates a result of an attempted loading of a web resource by an application on the client device, where the web resource is hosted by server 110 (e.g., a web server). Server 112 adjusts a confidence score for server 110 based on the load report, the confidence score for server 110 representing an operational state of server 110. If the result of the attempted loading of the web resource indicated by the load report is an unsuccessful result, server 112 generates a response for the application on the client device (e.g., any of computing devices 102-106), based on the confidence score for server 110. Server 112 provides the generated response to the client device for processing by the application.

In example aspects, the generated response includes the confidence score, and the application (e.g., the web browser) on the client device (e.g., any of computing devices 102-106) determines whether the confidence score exceeds a preset threshold. If the confidence score does not to exceed the preset threshold, the application can display a notification on the client device that server 110 is nonoperational, and has been down for an approximate amount of time. If the confidence score exceeds the preset threshold, the application can display a generic error message on the client device related to failure to connect to server 110. Alternatively, or in addition, if the confidence score exceeds the preset threshold, the application can automatically reattempt loading of the web resource hosted by server 110.

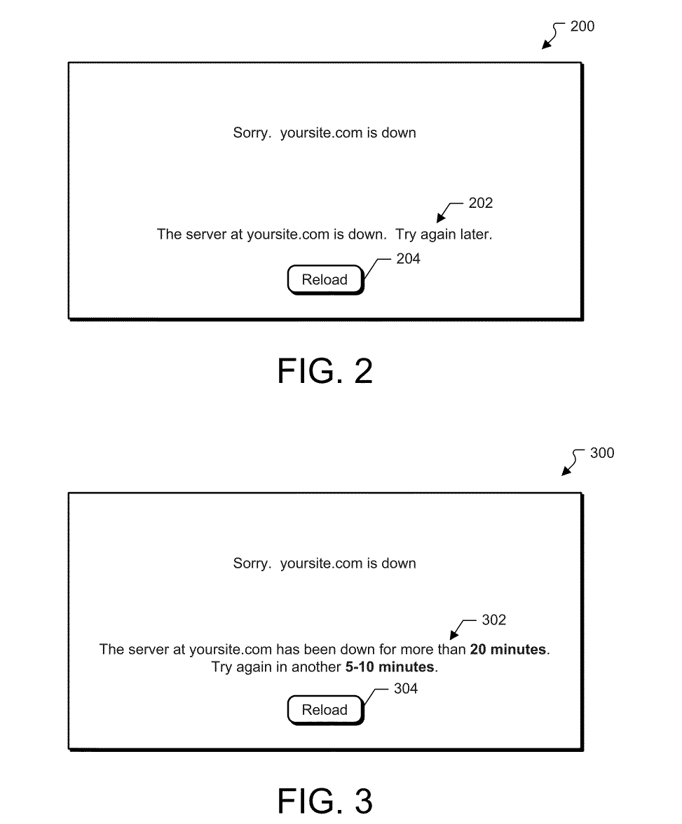

FIG. 2 illustrates an example of a graphical interface which provides notification of an unsuccessful attempt to load a web resource from a web server. In the example of FIG. 2, a notification 200 is displayed within an application (e.g., a web browser) running on a client device (e.g., any of computing devices 102-106). The notification is provided in response to an unsuccessful attempt by the client device to load a web resource e.g., a webpage) from a web server (e.g., server 110).

Notification 200 includes an error message 202 which is a generic error message. As seen in FIG. 2, error message 202 simply indicates that the web server is down. In this example, error message 202 states “The server at yoursite.com is down. Try again later.” In other examples, the error message may simply state that the web resource was unable to load. This may suggest that the server may be operational, but that another issue prevents the web resource from loading (e.g., connectivity issues associated with the client device. As noted above, generic error message 202 may not provide the user with any guidance as to how to respond to the failed attempt to load the web resource.

Notification 200 also includes a reload button 204. Reload button 204 is an interface which a user can select to manually reattempt to load the web resource (e.g., the webpage) from the web server (e.g., server 110).

FIG. 3 illustrates another example of a graphical interface which provides notification of an unsuccessful attempt to load a web resource from a web server. In the example of FIG. 3, a notification 300 is displayed within an application (e.g., a web browser) running on a client device (e.g., any of computing devices 102-106). The notification is provided in response to an unsuccessful attempt by the client device to load a web resource (e.g., a webpage) from a web server (e.g., server 110).

Notification 300 includes an error message 302 which is more customized than error message 202, by including information in addition to a generic error message. As seen in FIG. 3, error message 302 indicates that a server is down, and has been down for an approximate time period. In addition, error message 302 can suggest a period of time that the user should wait before reattempting to load the web resource (e.g., webpage) hosted by the web server (e.g., server 110). In this example, error message 302 states “The server at yoursite.com has been down for more than 20 minutes. Try again in another 5-10 minutes.” Compared to the content provided by a generic error message, error message 302 provides the user with more guidance as to how to respond to the failed attempt to load the web resource.

Notification 300 also includes a reload button 304. Reload button 304 is an interface which a user can select to manually reattempt to load the web resource (e.g., the webpage) from the web server (e.g., server 110).

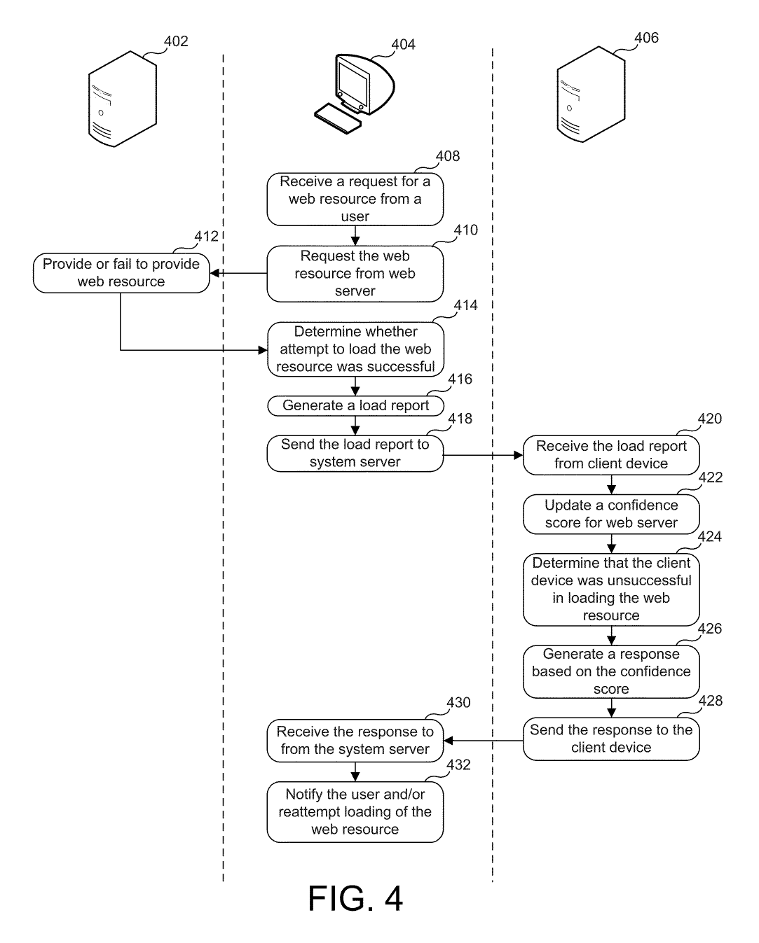

FIG. 4 illustrates an example process by which an attempted loading of a web resource is processed. The process of FIG. 4 can be associated with a client device 404, a web server 402 and a system server 406. In example aspects, client device 404 corresponds to any of computing devices 102-106 of FIG. 1, web server 402 corresponds to server 110, and system server 406 corresponds to server 112.

At step 408, client device 404 receives a request from a user to access a web resource (e.g., webpage), where the web resource is hosted by web server 402. For example, an application such as a web browser on client device 404 may be used to communicate with various web servers and load web resources hosted by those web servers. In the example of FIG. 4, at step 410, client device 404 requests a web resource from web server 402.

In some cases, when the application attempts to retrieve a web resource hosted by web server 402, web server 402 will respond, provide the web resource to the application on client device 404, and the web resource may be successfully loaded. In other cases, however, the application (e.g., web browser) may be unsuccessful in loading the web resource. Thus, at step 412, web server 402 either provides or fails to provide the web resource for client device 404. Client device 404 determines whether the attempt to load the web resource was successful at step 414.

An example of failing to provide the web resource includes, but is not limited to, a timeout occurring on client device 404. The timeout corresponds to a predetermined period of time during which client device 404 does not receive the web resource from web server 402.

Reasons for a timeout can vary. For example, the timeout can occur if web server 402 is not in an operational state, thereby being unavailable to provide web resources in response to any request (e.g., from client devices other than client device 404). In another example, the timeout can occur for client device 404, but not necessarily for other client devices accessing web resources from web server 402. For example, a network issue (e.g., firewall, connection issue) can prevent client device 404 from accessing a web resource from web server 402.

At step 416, client device 404 generates a load report indicating the result of the loading of the resource by the application running on client device 404. At step 418, client device sends the load report to system server 406, and system server 406 receives the load report at step 420.

In this regard, software (e.g., a plug-in for the application running on client device 404, or another computer program) on client device 404 may be configured to generate and transmit a load report to system server 406. The load report may contain information about the result of the attempted loading of the web resource by the application. For example, the load report may include the uniform resource locator (URL) for the web resource that the application (e.g., web browser) attempted to load, an indication as to whether the attempt to load the web resource succeeded or failed, and a client identifier such as an internee protocol (IP) address of client device 404 or other identifier.

At step 422, system server 406 updates a confidence score for web server 402. In this regard, system server 406 may receive load reports from a number of users (e.g., client devices) over the Internet and use the load reports to determine the status of one or more web servers (e.g., web server 402).

In example aspects, for each load report received by system server 406, system server 406 may submit a domain name system (DNS) lookup for the URL of the web resource that the web browser attempted to load, and may receive the IP address identifying the web server (e.g., web server 402) hosting the web resource. System server 406 may then store the indication as to whether the attempt to load the web resource succeeded or failed, together with the client identifier from the load report in a record for web server 402.

System server 406 may attempt to determine the status of web server 402 hosting the web resource that the application attempted to access, by calculating a confidence score for web server 402 based on the data in the web server 402's record. The confidence score may represent system server 406's determination as to whether web server 402 is operational or nonoperational, and/or a level of certainty as to whether web server 402 is operational.

In example aspects, the confidence score may be calculated based on a ratio of the number of unsuccessful attempts to reach web server 402 over the number of successful attempts over a particular time period (e.g., the past hour). If the confidence score is above a first threshold value, web server 402 may be considered as running or under normal operating conditions. If the confidence score is below or equal to a second threshold value, web server 402 may be considered as down or nonoperational.

In example aspects, the first and second threshold values may be equal. Thus, web server 402 server can be determined to be operational or nonoperational. In other aspects, the first and second threshold values may differ. In this regard, if the confidence level does not meet either condition (e.g., the confidence level is between the first and second threshold values), or if there is not enough data in the web server's record to calculate a confidence score with certainty, the web server status may be considered unknown or inconclusive. In this regard, the confidence score can be based on a minimum duration and a minimum number of reports received from different client devices. Thus, depending on the confidence level, web server 402 can be determined to be operational, nonoperational, or unknown.

In the example of FIG. 4, at step 424, system server 406 determines that client device 404 was unsuccessful in loading the web resource, based on the load report provided by client device 424. The process then proceeds to step 426, in which system server 406 generates a response for the application on client device 404, based on the confidence score for the web server. At step 428, system server 406 sends the generated response to client device 404, and client device 404 receives the response at step 430.

The response transmitted from system server 406 to client device 404 can provide guidance to client device 404 for how to attend to the unsuccessful load attempt. In example aspects, the response can be generated based on the adjusted confidence score. Alternatively, it is possible for the response to be generated based on the confidence score before adjustment corresponding to prior attempts for other client device(s) to connect to web server 402).

It should be noted that if the load report received from client device 404 indicates that the result of the attempted load of the web resource was successful, there may be no need for system server 406 to generate (and provide) client device 404 with the status of web server 402. However, if the load report received from the client device indicates that the result of the attempted load of the web resource was unsuccessful, system server 406 can generate (and provide) the status of web server 402 to client device 404. Client device 404 may then use the status of 402 web server in order to provide an appropriate response.

Thus, if system server 406 determines that client device 404 was successful in loading the web resource, the process can end and skip process steps 426-432. Utile client device 404 successfully loaded the web resource from web server 402, the successful load report is simply reported to system server 406 for updating the confidence score.

At step 432, client device 404 provides for notifying the user and/or reattempting to load the web resource, based on the received response. In particular, in response to receiving the web server status (e.g., the generated response) from system server 406, client device 404 can display a message that informs the user of the status of the web server and/or can reattempt to load the web resource.

For example, if client device 404 receives an indication that the operational state of web 402 server is unknown, client device 404 may be configured to display a generic error message (e.g., error message 202 of FIG. 2). In addition, if client device 404 receives an indication that the web server is up or operating normally, client device 404 may display the generic error message. Alternatively, or in addition, upon receiving the indication that web server 402 is operating normally, client device 404 may reattempt to automatically reload the web resource from web server 402.

If system server 406 determines that web server 402 is down or otherwise nonoperational, in addition to transmitting the down status to client device 404, system server 406 may provide other information to client device 404. This other information can include how long web server 402 has been down, how many other users (e.g., client devices) have been unsuccessful in reaching web server 402, or any other information about web server 402 that system server 406 has access to. In response to receiving the information from system server 406, client device 404 may generate amore customized error message (e.g., error message 302 of FIG. 3) to display to the user of client device 404.

As noted above with reference to FIG. 3, the customized error message may include information such as an approximate time that the web server has been down (e.g., based on a first unsuccessful response by web server 402 within a preset duration), a number of other users that have attempted unsuccessfully to reach the web server, and/or a recommended response. In example aspects, the recommended response may be generated by software on client device 404. Alternatively, or in addition, the recommended response may be generated by system server 406 and transmitted to client device 404.

The customized error message may include a counter indicating a period of time before which the user should try to reach the web server again. The counter can be based on the approximate time that web server 402 has been down. For example, the longer the amount of time web server 402 has been down, the greater the counter time for suggesting when the user should reattempt to load the web resource. In example aspects, once the counter expires, client device 404 may automatically attempt to load the web resource without further user interaction.

Although the variations described above discuss determining the status of a web server that hosts the web resource that the browser is attempting to load, in other examples, it should be noted that system server 406 may be configured to determine the status for the web resource being accessed or the web domain of the web resource instead of or in addition to determining the status of the web server.

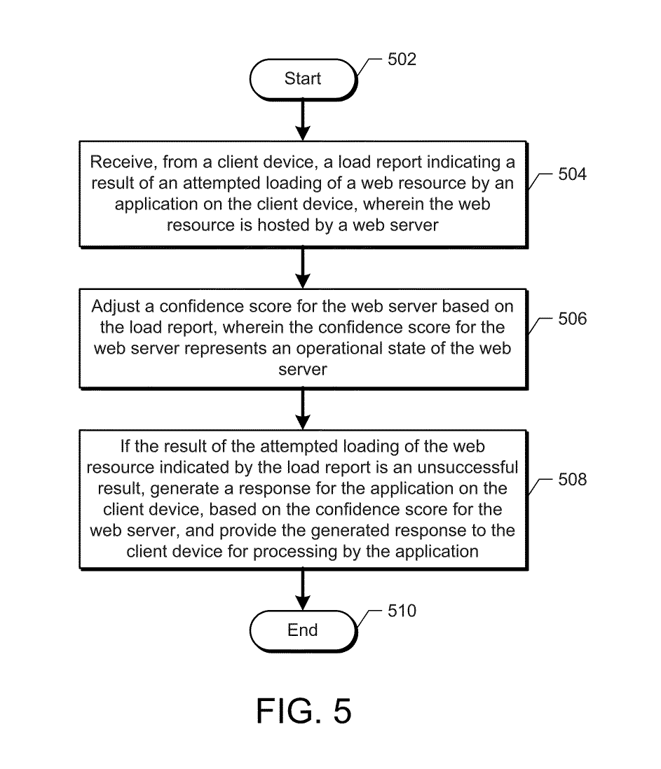

FIG. 5 illustrates another example process by which an attempted loading of a web resource is processed. In example aspects, the process of FIG. 5 is performed by a system server (e.g., system server 406 of FIG. 4). Following start block 502, a load report is received from a client device at step 504. The load report indicates a result of an attempted loading of a web resource by an application on the client device, and the web resource is hosted by a web server.

At step 506, a confidence score is adjusted for the web server based on the load report. The confidence score for the web server represents an operational state of the web server. The confidence score can represent a level of certainty that the web server is operational. For example, the confidence score can represent a ratio of a number of unsuccessful attempts to access the web server over a number of successful attempts to access the web server over a predetermined time period.

The load report can include a uniform resource locator (URL) for the web server, the method further comprising identifying the web server based on the URL. The adjusting can include adjusting the confidence score for the identified web server. The identifying can include performing a domain name system (DNS) lookup for the LIRE to determine an internet protocol (IP) address for identifying the web server. Alternatively, or in addition, the load report can include an identifier for identifying the client device.

At step 508, if the result of the attempted loading of the web resource indicated by the load report is an unsuccessful result, a response is generated for the application on the client device, based on the confidence score for the web server, and the generated response is provided to the client device for processing by the application.

The generated response can include the confidence score, and the application can be configured to determine whether the confidence score exceeds a preset threshold. If the confidence score is determined not to exceed the preset threshold, the application can further be configured to display a notification that the web server is nonoperational. The notification that the web server is nonoperational can include a time period since a first unsuccessful response by the web server within a preset duration.

If the confidence score is determined to exceed the preset threshold, the application can further be configured to display a generic error message associated with connecting to the web server. Alternatively, or in addition, if the confidence score is determined to exceed the preset threshold, the application can further be configured to automatically reattempt loading of the web resource hosted by the web server. The process then ends at end block 510.

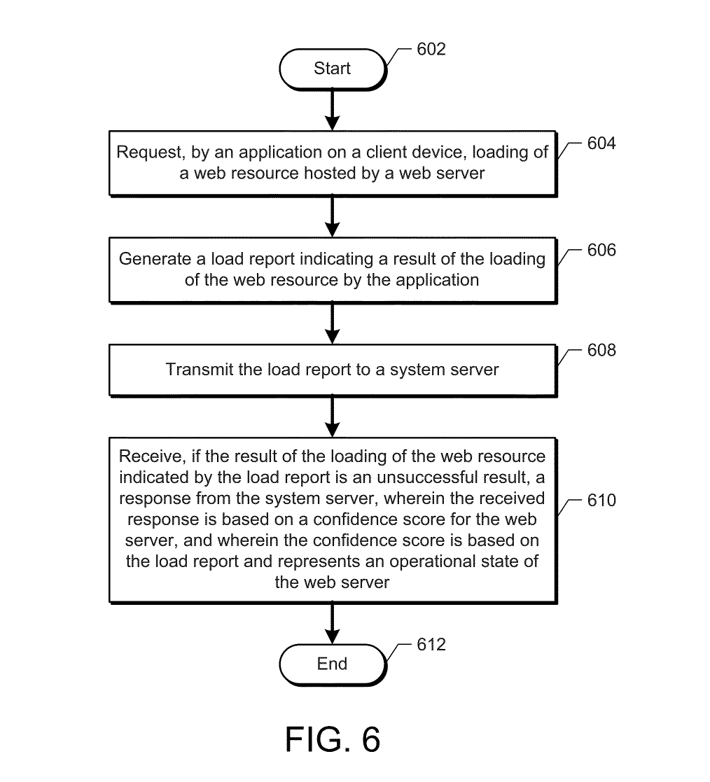

FIG. 6 illustrates yet another example process by which an attempted loading of a web resource is processed. In example aspects, the process of FIG. 5 is performed by a client device (e.g., client device 404 of FIG. 4). Following start block 602, the loading of a web resource hosted by a web server is requested by an application on a client device at step 604.

At step 606, a load report is generated. The load report indicates a result of the loading of the web resource by the application. At step 608, the load report is transmitted to a system server.

At step 610, if the result of the loading of the web resource indicated by the load report is an unsuccessful result, a response is received from the system server. The received response is based on a confidence score for the web server. The confidence score is based on the load report and represents an operational state of the web server.

A determination can be made whether the confidence score exceeds a preset threshold, based on the received response. If the confidence score is determined not to exceed the preset threshold, a notification that the web server is nonoperational can be displayed. The notification that the web server is nonoperational can include a time period since a first unsuccessful response by the web server within a preset duration.

If the confidence score is determined to exceed the preset threshold, a generic error message associated with connecting to the web server can be displayed. Alternatively, or in addition, if the confidence score is determined to exceed the preset threshold, loading of the web resource hosted by the web server can be automatically reattempted. The process then ends at end block 612.

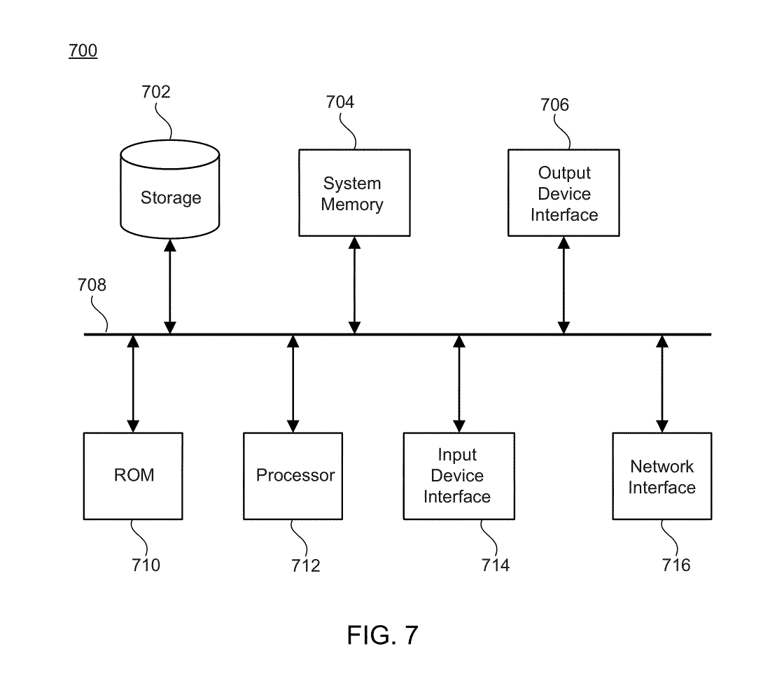

FIG. 7 conceptually illustrates an example electronic system with which some implementations of the subject technology can be implemented. Electronic system 700 can be a computer, phone, PDA, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (for example, a magnetic or optical disk and its corresponding disk drive) as permanent storage device 702.

Other implementations use a removable storage device (for example, a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, or ROM 710. For example, the various memory units include instructions for processing an attempted loading of a web resource in accordance with some implementations. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, for example, cathode ray tubes (CRT) or liquid crystal displays (LCD). Some implementations include devices, for example, a touchscreen that functions as both input and output devices.

Finally, as shown in FIG. 7, bus 708 also couples electronic system 700 to a network (not shown) through a network interface 716. In this manner, the computer can be a part of a network of computers (for example, a local area network (“LAN”), a wide area network (“WAN”), or an Intranet, or a network of networks, for example, the Internet. Any or all components of electronic system 700 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand atone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more,” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A machine-implemented method of processing an attempted loading of a web resource, the method comprising:
receiving, from a client device, a load report indicating a result of an attempted loading of a web resource by an application on the client device, wherein the web resource is hosted by a web server;
adjusting a confidence score for the web server based on the load report, wherein the confidence score for the web server represents an operational state of the web server; and
if the result of the attempted loading of the web resource indicated by the load report is an unsuccessful result,
generating a response for the application on the client device, based on the confidence score for the web server, and
providing the generated response to the client device for processing by the application.

2. The method of claim 1, wherein the confidence score represents a level of certainty that the web server is operational.

3. The method of claim 1, wherein the confidence score represents a ratio of a number of unsuccessful attempts to access the web server over a number of successful attempts to access the web server over a predetermined time period.

4. The method of claim 1, wherein the generated response includes the confidence score, and wherein the application is configured to determine whether the confidence score exceeds a preset threshold.

5. The method of claim 4, wherein if the confidence score is determined not to exceed the preset threshold, the application is further configured to display a notification that the web server is nonoperational.

6. The method of claim 5, wherein the notification that the web server is nonoperational includes a time period since a first unsuccessful response by the web server within a preset duration.

7. The method of claim 4, wherein if the confidence score is determined to exceed the preset threshold, the application is further configured to display a generic error message associated with connecting to the web server.

8. The method of claim 4, wherein if the confidence score is determined to exceed the preset threshold, the application is further configured to automatically reattempt loading of the web resource hosted by the web server.

9. The method of claim 1, wherein the load report comprises a uniform resource locator (URL) for the web server, the method further comprising identifying the web server based on the URL.

10. The method of claim 9, wherein the adjusting comprises adjusting the confidence score for the identified web server.

11. The method of claim 9, wherein the identifying comprises performing a domain name system (DNS) lookup for the URL to determine an internet protocol (IP) address for identifying the web server.

12. The method of claim 1, wherein the load report comprises an identifier for identifying the client device.

13. A machine-implemented method of processing an attempted loading of a web resource, the method comprising:
requesting, by an application on a client device, loading of a web resource hosted by a web server;
generating a load report indicating a result of the loading of the web resource by the application;
transmitting the load report to a system server;
receiving, if the result of the loading of the web resource indicated by the load report is an unsuccessful result, a response from the system server,
wherein the received response is based on a confidence score for the web server, and
wherein the confidence score is based on the load report and represents an operational state of the web server.

14. The method of claim 13, further comprising:
determining, based on the received response, whether the confidence score exceeds a preset threshold.

15. The method of claim 14, further comprising:
displaying, if the confidence score is determined not to exceed the preset threshold, a notification that the web server is nonoperational.

16. The method of claim 15, wherein the notification that the web server is nonoperational includes a time period since a first unsuccessful response by the web server within a preset duration.

17. The method of claim 14, further comprising:
displaying, if the confidence score is determined to exceed the preset threshold, a generic error message associated with connecting to the web server.

18. The method of claim 14, further comprising:
automatically reattempting, if the confidence score is determined to exceed the preset threshold, loading of the web resource hosted by the web server.

19. A system for processing an attempted loading of a web resource, the system comprising:
one or more processors; and
a machine-readable medium comprising instructions stored therein, which when executed by the processors, cause the processors to perform operations comprising:
receiving, from a client device, a load report indicating a result of an attempted loading of a web resource by an application on the client device, wherein the web resource is hosted by a web server;
adjusting a confidence score for the web server based on the load report, wherein the confidence score for the web server represents a level of certainty that the web server is operational; and
if the result of the attempted loading of the web resource indicated by the load report is an unsuccessful result,
generating a response for the application on the client device, based on the confidence score for the web server, and
providing the generated response to the client device for processing by the application.

20. A system for processing an attempted loading of a web resource, the system comprising:
one or more processors; and
a machine-readable medium comprising instructions stored therein, which when executed by the processors, cause the processors to perform operations comprising:
requesting, by an application on a client device, loading of a web resource hosted by a web server;
generating a load report indicating a result of the loading of the web resource by the application;
transmitting the load report to a system server;
receiving, if the result of the loading of the web resource indicated by the load report is an unsuccessful result, a response from the system server,
wherein the received response is based on a confidence score for the web server, and
wherein the confidence score is based on the load report and represents a level of certainty that the web server is operational.
